(19) United States
(12) Patent Application Publication
(10) Pub. No.: US 2025/0013980 A1
(43) Pub. Date: Jan. 9, 2025

(54) METHOD AND APPARATUS FOR A VISUAL TRIGGER FOR WAREHOUSE INVENTORY REPLENISHMENT

(71) Applicant: Electronic Power Design, Inc., houston, TX (US)

(72) Inventors: Andrea Melissa Alvarado Miranda, Spring (PA); PATRICK Anthony James Gaffney, Sugarland (GB)

(73) Assignee: Electronic Power Design, Inc., houston, TX (US)

(21) Appl. No.: 18/232,366

(22) Filed: Aug. 10, 2023

Related U.S. Application Data
(60) Provisional application No. 63/524,974, filed on Jul. 5, 2023.

(51) Int. Cl. G06Q 10/087

(52) U.S. Cl. CPC G06Q 10/087

(57) ABSTRACT

A method for warehouse inventory replenishment, providing a kanban card comprising multiple field areas; associating the kanban card with an internal product line; assigning a color representative of the internal product line to the kanban card; designating a supplier for the part associated with the kanban card; identifying a material type for the part on the kanban card; calculating a lot size for the part based on lead time, part dimensions, rack clearance, and demand; determining an appropriate number of kanban cards to support loading levels; indicating a lead time for purchase orders for the part on the kanban card; specifying a pallet type for the part on the kanban card; defining warehouse locations for the part indicated on the kanban card as “pick” and “reserve”; encoding a barcode corresponding to the part number on the kanban card; displaying a color coded loading level associated with the kanban card; using the color coded loading level as a visual trigger for inventory shortages; reporting inventory shortages indicated by the visual trigger to an enterprise resource planning analyst; ordering additional parts associated with the inventory shortages; and restoring supply to meet loading level requirements based on the ordered additional parts.

### CROSS REFERENCE TO RELATED APPLICATIONS

This patent application claims priority from U.S. provisional patent application Ser. No. 63/524,974 filed on Jul. 5, 2023, by Andrea Melissa Alvarado Miranda et al. and entitled, “A Method And Apparatus For A Visual Trigger For Warehouse Inventory Replenishment,” which is hereby incorporated by reference in its entirety.

### BACKGROUND OF THE INVENTION

Warehouse inventory management is typically difficult to efficiently maintain.

### FIELD OF THE INVENTION

The field of the present invention is warehouse inventory management.

### SUMMARY OF THE INVENTION

An apparatus and method for warehouse inventory replenishment, providing a kanban card comprising multiple field areas; associating the kanban card with an internal product line; assigning a color representative of the internal product line to the kanban card; designating a supplier for the part associated with the kanban card; identifying a material type for the part on the kanban card; calculating a lot size for the part based on lead time, part dimensions, rack clearance, and demand; determining an appropriate number of kanban cards to support loading levels; indicating a lead time for purchase orders for the part on the kanban card; specifying a pallet type for the part on the kanban card; defining warehouse locations for the part indicated on the kanban card as “pick” and “reserve”; encoding a barcode corresponding to the part number on the kanban card; displaying a color coded loading level associated with the kanban card; using the color coded loading level as a visual trigger for inventory shortages; reporting inventory shortages indicated by the visual trigger to an enterprise resource planning analyst; ordering additional parts associated with the inventory shortages; and restoring supply to meet loading level requirements based on the ordered additional parts.

### BRIEF DESCRIPTION OF THE DRAWINGS

FIG. 1 is a top view of an illustrative embodiment of the invention.

The drawings presented herein are for illustrative purposes only and do not limit the scope of the claims. Rather, the drawings are intended to help enable one having ordinary skill in the art to make and use the claimed inventions.

### DETAILED DESCRIPTION OF AN ILLUSTRATIVE EMBODIMENT OF THE INVENTION

A detailed description will now be provided. The purpose of this detailed description, which includes the drawings, is to satisfy the statutory requirements of 35 U.S.C. § 112. For example, the detailed description includes a description of inventions defined by the claims and sufficient information that would enable a person having ordinary skill in the art to make and use the inventions. In the FIGURES, like elements are generally indicated by like reference numerals regardless of the view or FIGURE in which the elements appear. The figures are intended to assist the description and to provide a visual representation of certain aspects of the subject matter described herein. The figures are not all necessarily drawn to scale, nor do they show all the structural details nor do they limit the scope of the claims.

In a particular illustrative embodiment of the invention, a smart card, referred to herein as a Kanban card is presented. In a particular illustrative embodiment of the invention, Kanban Cards are used as part of a warehouse replenishment process. The Kanban card's purpose is to provide all the information necessary for a part to be ordered, received, put away and consumed in a continuous cycle. The Kanban cards provide the following information to the groups involved in maintaining warehouse inventory and simplifies the process.

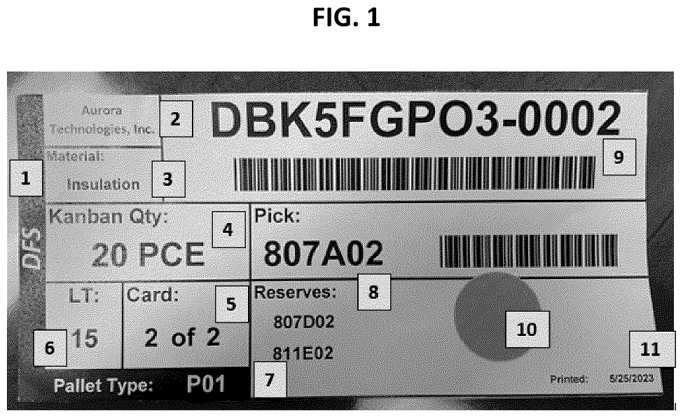

As shown in FIG. 1, in a particular illustrative embodiment of the invention, field area 1 on the Kanban Card identifies the internal product line associated with the card, in this case the internal product line is identified as “DFS” or Deadfront Switchboard. The color of the card is also representative of the product line, in the case of DFS product line, the color of the Kanban Card is blue. Field area 2 on the Kanban card shows an area on the Kanban Card that identifies a supplier or suppliers of associated with the part. In the present example a supplier named Aurora Technologies is indicated. Some parts have multiple suppliers, so each Kanban card has the correct supplier noted.

Field area 3 on the Kanban Card identifies a material type for the part. Examples of material types include but are not limited to insulation, sheet metal, copper, electrical components etc. In the present example of an illustrative embodiment, the material type is identified as “insulation.” In another particular embodiment of the invention, the specific material type, for example is indicated as CRS-14ga-48×120, which is the gauge and size of the raw material is provided in field area 3.

Field area 4 on the Kanban card refers to a calculated lot size assigned to the part. The lot size is based on lead time for ordering and receiving the part, part dimensions, rack clearance required, and demand. In a particular illustrative embodiment of the invention, the lot size is indicated as 20. The lot size takes into account price breaks and MOQs from vendors too.

Field area 5 on the Kanban card identifies an appropriate number of cards in the system to support our loading levels (average demand). Area 6 on the Kanban Card, LT is an abbreviation for Lead Time. This field is for purchasing as it provides a due date for the purchase orders for the part indicated on the Kanban card.

Field area 7 indicates a Pallet type, which refers to the size of a pallet the part indicated on the Kanban card must arrive or be transferred to. Different types of pallet are indicated, wherein, P01 is the smallest size, P05 is medium, and P09 is large.

Field area 8 on the Kanban card provides “pick” and “reserve” indicates the warehouse locations that the part indicated on the Kanban card can be transferred to when the part arrives into receiving. These locations are assigned specifically to this part and should not be occupied by anything else. Pick is designated for “kitters” (associates who pull parts for kits) to pull from. Reserves are locations that are typically out of reach that are not eligible to be picked from and the pallets are wrapped and stored ready to fill the pick location when it becomes empty.

Field area 9 provide a barcode in the pick field reflects that location and allows transfers to be made systematically. This is the part number associated with the Kanban card. The barcode reflects that part number and allows transfers, receipts and purchase orders to be made.

Field area 10 represents a color coded loading level associated with the Kanban card. A warehouse computer measures output by the number of switchgear sections that can ship each week. In this instance field area 10 is colored pink circle which represents a 60 section per week loading level. As this level increases or decreases the color will change. A green circle in field area 10 represents a 30 section per week loading level. Thus, if the current loading level is 60 a pink circle in field area 10 indicates that the loading level of 60 is supported, however, when a manager sees a green circle in field area 10, the green circle indicates that only a loading level of 30 is supported. The green circle is a visual trigger to a manager that the loading level is inadequate, that is, the loading level of 60 (pink circle) is not supported by part pallets with a green circle, which only supports a loading level of 30. Thus, the green circle is a visual trigger, that is, a manager in the warehouse seeing green circles on KanKards among the pallets in the warehouse having pink circles, triggers the manager to report a shortage of parts indicated by the green circles. The manager then reports the shortage indicated by the green circles to an enterprise resource planning analyst who orders more parts associated with the green circle so that the supply is brought back up to the pink circle level (60) so that the loading level of 60 will be supported by the new orders.

Field area 11 displays the printed date of the card which helps the a warehouser Supply Chain Team keep track of when the cards were introduced and how up to date they are.

In a particular illustrative embodiment of the invention, a method is provided for warehouse inventory replenishment, including but not limited to, providing a kanban card comprising multiple field areas; associating the kanban card with an internal product line; assigning a color representative of the internal product line to the kanban card; designating a supplier for a part associated with the kanban card; identifying a material type for the part on the kanban card; calculating a lot size for the part based on lead time, part dimensions, rack clearance, and demand; determining an appropriate number of kanban cards to support loading levels; indicating a lead time for purchase orders for the part on the kanban card; specifying a pallet type for the part on the kanban card; defining warehouse locations for the part indicated on the kanban card as “pick” and “reserve”; encoding a barcode corresponding to the part number on the kanban card; displaying a color coded loading level associated with the kanban card; using the color coded loading level as a visual trigger for inventory shortages; reporting inventory shortages indicated by the visual trigger to an enterprise resource planning analyst; ordering additional parts associated with the inventory shortages; and restoring supply to meet loading level requirements based on the ordered additional parts.

In another particular embodiment of the invention, an apparatus for warehouse inventory replenishment is provided, including but not limited to a kanban card including but not limited to multiple field areas; means for associating the kanban card with an internal product line; means for assigning a color representative of the internal product line to the kanban card; means for designating a supplier for a part associated with the kanban card; means for identifying a material type for the part on the kanban card; means for calculating a lot size for the part based on lead time, part dimensions, rack clearance, and demand; means for determining an appropriate number of kanban cards to support loading levels; means for indicating a lead time for purchase orders for the part on the kanban card; means for specifying a pallet type for the part on the kanban card; means for defining warehouse locations for the part indicated on the kanban card as “pick” and “reserve”; means for encoding a barcode corresponding to the part number on the kanban card; means for displaying a color coded loading level associated with the kanban card; m. means for using the color coded loading level as a visual trigger for inventory shortages; means for reporting inventory shortages indicated by the visual trigger to an enterprise resource planning analyst; means for ordering additional parts associated with the inventory shortages; and means for restoring supply to meet loading level requirements based on the ordered additional parts.

In another particular embodiment of the invention, a kanban card for warehouse inventory replenishment, is provided, including but not limited to a first field area indicating an internal product line associated with the card; a second field area indicating a supplier for a part associated with the card; a third field area indicating a material type for the part; a fourth field area indicating a calculated lot size for the part; a fifth field area indicating an appropriate number of cards to support loading levels; a sixth field area indicating a lead time for purchase orders for the part; a seventh field area indicating a pallet type for the part; an eighth field area indicating warehouse locations for the part as “pick” and “reserve”; a ninth field area providing a barcode corresponding to the part number; a tenth field area displaying a color coded loading level associated with the card; and an eleventh field area showing a printed date of the card.

In another particular embodiment of the invention, a method is provided for identifying inventory shortages in a warehouse, the method including but not limited to displaying a plurality of kanban cards, each card associated with a warehouse part; indicating a color coded loading level on each kanban card; using the color coded loading level as a visual trigger; identifying a first loading level corresponding to a first color on a kanban card; identifying a second loading level corresponding to a second color on a kanban card; recognizing that the second loading level is lower than the first loading level; reporting a shortage of parts associated with the second loading level to an enterprise resource planning analyst; and ordering additional parts to restore supply and meet a first loading level requirement.

Each of the appended claims defines a separate invention which, for infringement purposes, is recognized as including equivalents of the various elements or limitations specified in the claims. Depending on the context, all references below to the “invention” may in some cases refer to certain specific embodiments only. In other cases, it will be recognized that references to the “invention” will refer to the subject matter recited in one or more, but not necessarily all, of the claims. Each of the inventions will now be described in greater detail below, including specific embodiments, versions, and examples, but the inventions are not limited to these specific embodiments, versions, or examples, which are included to enable a person having ordinary skill in the art to make and use the inventions when the information in this patent is combined with available information and technology. Various terms as used herein are defined below, and the definitions should be adopted when construing the claims that include those terms, except to the extent a different meaning is given within the specification or in express representations to the Patent and Trademark Office (PTO). To the extent a term used in a claim is not defined below or in representations to the PTO, it should be given the broadest definition persons having skill in the art have given that term as reflected in at least one printed publication, dictionary, or issued patent.

Certain specific embodiments of methods, structures, elements, and parts are described below, which are by no means an exclusive description of the inventions. Other specific embodiments, including those referenced in the drawings, are encompassed by this application and any patent that is issued therefrom.

1: A method for warehouse inventory replenishment, comprising:
providing a kanban card comprising multiple field areas;
associating the kanban card with an internal product line;
assigning a color representative of the internal product line to the kanban card;
designating a supplier for a part associated with the kanban card;
identifying a material type for the part on the kanban card;
calculating a lot size for the part based on lead time, part dimensions, rack clearance, and demand; determining an appropriate number of kanban cards to support loading levels;
indicating a lead time for purchase orders for the part on the kanban card;
specifying a pallet type for the part on the kanban card;
defining warehouse locations for the part indicated on the kanban card as “pick” and “reserve”;
encoding a barcode corresponding to the part number on the kanban card;
displaying a color coded loading level associated with the kanban card;
using the color coded loading level as a visual trigger for inventory shortages;
reporting inventory shortages indicated by the visual trigger to an enterprise resource planning analyst;
ordering additional parts associated with the inventory shortages; and
restoring supply to meet loading level requirements based on the ordered additional parts.

2: An apparatus for warehouse inventory replenishment, comprising:
a kanban card comprising multiple field areas;
means for associating the kanban card with an internal product line;
means for assigning a color representative of the internal product line to the kanban card;
means for designating a supplier for a part associated with the kanban card;
means for identifying a material type for the part on the kanban card;
means for calculating a lot size for the part based on lead time, part dimensions, rack clearance, and demand;
means for determining an appropriate number of kanban cards to support loading levels;
means for indicating a lead time for purchase orders for the part on the kanban card;
means for specifying a pallet type for the part on the kanban card;
means for defining warehouse locations for the part indicated on the kanban card as “pick” and “reserve”;
means for encoding a barcode corresponding to the part number on the kanban card;
means for displaying a color coded loading level associated with the kanban card;
means for using the color coded loading level as a visual trigger for inventory shortages;
means for reporting inventory shortages indicated by the visual trigger to an enterprise resource planning analyst;
means for ordering additional parts associated with the inventory shortages; and
means for restoring supply to meet loading level requirements based on the ordered additional parts.

3: A kanban card for warehouse inventory replenishment, comprising:
a first field area indicating an internal product line associated with the card;
a second field area indicating a supplier for a part associated with the card;
a third field area indicating a material type for the part;
a fourth field area indicating a calculated lot size for the part;
a fifth field area indicating an appropriate number of cards to support loading levels;
a sixth field area indicating a lead time for purchase orders for the part;
a seventh field area indicating a pallet type for the part;
an eighth field area indicating warehouse locations for the part as “pick” and “reserve”;
a ninth field area providing a barcode corresponding to the part number;
a tenth field area displaying a color coded loading level associated with the card; and
an eleventh field area showing a printed date of the card.

4: A method for identifying inventory shortages in a warehouse, comprising:
displaying a plurality of kanban cards, each card associated with a warehouse part;
indicating a color coded loading level on each kanban card;
using the color coded loading level as a visual trigger;
identifying a first loading level corresponding to a first color on a kanban card;
identifying a second loading level corresponding to a second color on a kanban card;
recognizing that the second loading level is lower than the first loading level;
reporting a shortage of parts associated with the second loading level to an enterprise resource planning analyst; and
ordering additional parts to restore supply and meet a first loading level requirement.
